(19) United States
(12) Patent Application Publication
(10) Pub. No.: US 2020/0143674 A1
(43) Pub. Date: May 7, 2020

(54) Forecasting a Traffic Light Switching State During a Journey of a Motor Vehicle

(71) Applicant: Continental Automotive GmbH, Hannover (DE)

(72) Inventor: Thomas Wölfl, Regensburg (DE)

(73) Assignee: Continental Automotive GmbH, Hannover (DE)

(21) Appl. No.: 16/616,474

(22) PCT Filed: May 22, 2018
(86) PCT No.: PCT/EP2018/063317

§ 371 Date: Nov. 24, 2019

(30) Foreign Application Priority Data
May 24, 2017 (DE) 10 2017 208 878.8

(51) Int. Cl. G08G 1/096; G08G 1/095; G08G 1/0967; G08G 1/01; B60W 30/18

(52) U.S. Cl. CPC G08G 1/096; G08G 1/095; B60W 30/18027; G08G 1/0129; G08G 1/096708

(57) ABSTRACT

Various embodiments include a method for forecasting a traffic light switching state of a traffic light for an expected passing direction, wherein the traffic light is to be passed by a motor vehicle during a journey. The method may include: defining a triggering event for a predetermined stopping point on a route ahead of the traffic light; accessing a frequency distribution indicating a respective number of traffic light switching states observed in the past for various time intervals elapsed since the triggering event based at least in part on the triggering event and an expected passing direction; detecting the triggering event at the stopping point; determining an expected time of arrival at the traffic light for the motor vehicle; and estimating the traffic light switching state for the expected passing direction for the time of arrival on the basis of the frequency distribution.

### CROSS-REFERENCE TO RELATED APPLICATIONS

This application is a U.S. National Stage Application of International Application No. PCT/EP2018/063317 filed May 22, 2018, which designates the United States of America, and claims priority to DE Application No. 10 2017 208 878.8 filed May 24, 2017, the contents of which are hereby incorporated by reference in their entirety.

### TECHNICAL FIELD

The present disclosure relates to traffic systems. Various embodiments may include methods for predicting or forecasting a traffic light switching state of a traffic light. The forecast may be provided during a journey of a motor vehicle.

### BACKGROUND

DE 10 2013 223 022 A1 describes a statistical model which can model a switching behavior of a traffic light on the basis of a Kalman filter. A disadvantage in the modeling of the switching behavior of a single traffic light is that, although the relative switching times within a switching cycle can be determined, the absolute times at which a traffic light switches are not known. Therefore, if a motor vehicle approaches a traffic light and it is not known in what phase the switching cycle is at that time, then it cannot be predicted by means of such a model when the traffic light will switch the next time, because the model first has to be synchronized with the traffic light.

DE 10 2011 083 677 A1 describes forecasting a future traffic situation on the basis of a simulated journey. This is based on the one hand on historical data for determining statistical traffic characteristics and on the other hand on an indication of the current state of the vehicle, i.e. for example its position and/or driving speed. The simulation of the journey assumes that absolute switching times of traffic lights are known. However, this requires the procurement of planning data by which the switching times are specified.

### SUMMARY

The present disclosure describes systems and methods for forecasting in a motor vehicle the switching state for at least one following traffic light along a route. For example, some embodiments include a method for forecasting a traffic light switching state (S) of a traffic light (32) for an expected passing direction (A2), in which the traffic light (32) is to be passed by a motor vehicle (10) during a journey, wherein: a triggering event (14) is defined for a predetermined stopping point (13) on a route (11) ahead of the traffic light (32) and a frequency distribution (16) which indicates a respective number (31) of traffic light switching states (S) observed in the past for various time intervals (ΔT) that have elapsed since the triggering event (14) is provided for the triggering event (14) and the expected passing direction (A2), and at the stopping point (13) the triggering event (14) is actually detected and a time of arrival (33) at the traffic light (32) is determined and the traffic light switching state (S) for the passing direction (A2) under consideration is forecast for the time of arrival (33) on the basis of the frequency distribution (16).

In some embodiments, in the event that the route (11) leads over an intersection (K1, K2, K3) connecting a number of roads (29), the passing direction (A2) indicates via which possible stopping point (13) of the intersection (K1, K2, K3) the motor vehicle (10) reaches the intersection (K1, K2, K3) and at which next stopping point (13′) the motor vehicle (10) leaves the intersection (K1, K2, K3).

In some embodiments, a most probable route or a route signaled by a navigation device of the motor vehicle (10) is used as a basis for the passing direction (A1).

In some embodiments, a matrix (40) is provided, which, for a number of possible stopping points (41), indicates for at least one following traffic light (32, 32′) in each case a respective frequency distribution (16, 16′, 16″) for its traffic light switching state (S) for possible passing directions (42).

In some embodiments, in addition to the stopping point (13), a frequency distribution (16″) is also provided for at least one further stopping point (13′) along the route (11) for another triggering event (14′), and the frequency distributions (16′, 16″) of each stopping point (13, 13′) at which the respective triggering event (14, 14′) was detected are combined to forecast the traffic light switching state (S) by the frequency distribution (16′) of the last stopping point (13′) being used as a basis and any remaining frequency distribution (16″) adjusted with a respectively associated time offset, which corresponds to a travel time (TF) up to the last stopping point (13′).

In some embodiments, during a stopping phase at the traffic light (32), an actual traffic light switching state (S) of the traffic light (32) is detected and, on the basis of the respectively detected actual traffic light switching state (S) and the respective time interval (ΔT) since detecting the triggering event (14), the frequency distribution (16) is updated.

In some embodiments, a current, actual traffic light switching state (S) of the traffic light (32) is detected by means of a detection device (25) during an approach to the traffic light (32) and the frequency distribution (16) is updated on the basis of the detected actual traffic light switching state (S).

In some embodiments, from at least one further motor vehicle, state data concerning a respective actual traffic light switching state (S) of the traffic light (32) detected by the further motor vehicle are received and the frequency distribution (16) is updated on the basis of the state data.

In some embodiments, the frequency distribution (16) is selected from a number of frequency distributions, depending on the date and/or the time of day and/or traffic density indications.

In some embodiments, an internal combustion engine of a hybrid drive of the motor vehicle (10) and/or a start/stop function of an internal combustion engine and/or an output device for outputting a notification of the switching state of the traffic light to a driver of the motor vehicle is controlled in dependence on the forecast traffic light switching state (S) of the traffic light (32).

In some embodiments, a stopping position at a traffic light (12) is provided as a stopping point (13) and the triggering event (14) represents driving off at the traffic light (12).

As another example, some embodiments include a control device (15) for a motor vehicle (10), wherein the control device (15) has a processor device which is set up to carry out a method as described above.

As another example, some embodiments include motor vehicle (10) with a control device (15) as described above.

As another example, some embodiments include a server device (22), which is set up to receive respectively from a number of motor vehicles (10) state data (27) concerning a predetermined triggering event (14) and a respective traffic light switching state (S), detected by the motor vehicle (10), of a traffic light (32) passed in a passing direction (A1) with time data concerning a respective detection time of the detected traffic light switching state (S) and, on the basis of the state data (27) with the time data of all of the motor vehicles (10) for the respective triggering event (14) and the passing direction (A1), to generate and provide a frequency distribution (16), the frequency distribution (16) indicating a respective number (31) of the observed traffic light switching states (S) for different time intervals (ΔT) that have elapsed since the respective triggering event (14).

### BRIEF DESCRIPTION OF THE DRAWINGS

An exemplary embodiment of the teachings herein is described below, For this purpose, in the figures:

FIG. 1 shows a schematic representation of an embodiment of the motor vehicle incorporating teachings of the present disclosure;

FIG. 2 shows a diagram for illustrating an exemplary driving situation of the motor vehicle from FIG. 1;

FIG. 3 shows a diagram with a schematic progression of a frequency distribution;

FIG. 4 shows a diagram with schematic progressions of two frequency distributions for different stopping points;

FIG. 5 shows a diagram for illustrating the generation of a frequency distribution; and

FIG. 6 shows a schematic representation of a matrix for providing a number of frequency distributions for different stopping points at which a triggering event has been detected, and different stopping points at traffic lights together with the respective passing direction at the traffic light.

### DETAILED DESCRIPTION

The teachings of the present disclosure include methods and/or systems for forecasting or predicting a traffic light switching state of at least one traffic light. The method is initially described below for a single traffic light. The method can be extended correspondingly for a number of traffic lights. The method forecasts the traffic light switching state for a motor vehicle that is traveling along a route lying ahead of the traffic light and leading to the traffic light. By means of the method it is possible to perform said “synchronization” to a switching cycle of the traffic light, so that the current phase of the switching cycle is known. The synchronization takes place at a stopping point which is upstream along the route of the traffic light, which is therefore passed through first by the motor vehicle before the motor vehicle approaches the traffic light. The synchronization is based on a triggering event at the stopping point. The triggering event may be for example driving off or starting at the stopping point. Based on this triggering event, the switching behavior of the traffic light following in the direction of travel is then forecast. The forecast of the switching behavior refers in this case to the expected passing direction in which the traffic light will be passed by the vehicle.

The switching behavior may be described by means of a frequency distribution. The frequency distribution indicates a respective number of traffic light switching states observed in the past (for example “red” or “green”) for various time intervals that have elapsed since the triggering event. The frequency distribution therefore relates relatively to the event time of the triggering event. A time interval may therefore indicate for example: 10 seconds after the triggering event or 20 seconds after the triggering event or 30 seconds after the triggering event. Assigned to each time interval by the frequency distribution is how often or with what probability a certain traffic light switching state exists (for example “75% red”, “80% red”).

The frequency can be converted to the probability, for example by assigning to the largest number a probability value of 100% or 1 and assigning to the remaining values a smaller probability value proportional thereto. For the frequency distribution, it does not matter here how far away the traffic light is from the stopping point. The frequency distribution merely indicates in which time interval (in relation to the event time) this traffic light has which traffic light switching state. The frequency distribution takes into account the passing direction at the traffic light. For example, a distinction is made as to whether at the traffic light the traffic light switching state is indicated for driving straight ahead or for turning right or turning left. In the event that the route leads over an intersection connecting a number of roads, the passing direction therefore indicates via which possible stopping point of the intersection the motor vehicle reaches the intersection and at which next stopping point of the next traffic light the motor vehicle leaves the intersection.

In some embodiments, a triggering event is defined for a stopping point located ahead of the traffic light on a route, and a frequency distribution which indicates a respective number of traffic light switching states observed in the past for various time intervals that have elapsed since the triggering event is provided for the triggering event and the passing direction expected at the traffic light.

If the motor vehicle then drives along the route, the stopping point the triggering event is actually detected and a time of arrival at the traffic light is determined and the traffic light switching state for the expected passing direction and for the calculated time of arrival is forecast on the basis of the frequency distribution. The determining may be a computation or may be by sorting or searching within the frequency distribution. In some embodiments, as from the stopping point, whenever the triggering event is detected, a traffic light switching state of a traffic light following or downstream on the route for a certain passing direction and for the anticipated time of arrival can be predicted or forecast for the motor vehicle.

If a motor vehicle approaches an intersection, to forecast the traffic light switching state it must be determined in which passing direction the motor vehicle will pass the traffic light, i.e. where the route will lead. In some embodiments, a most probable route or a route signaled by a navigation device of the motor vehicle is used as a basis for the passing direction. The most probable route may for example lead along a main road, i.e. the most major road may be used as a basis. Traffic statistics may also be used as a basis for determining the most probable route. The individual driving behavior of the motor vehicle and/or of a specific driver of the motor vehicle is preferably used as a basis (so-called individualized most probable path). For this purpose, historical driving data may be used as a basis, i.e. the passing direction may be estimated from the driving behavior of the own motor vehicle. If the current route is known from a navigation device of the motor vehicle, its course can of course be used as a basis. The most probable route may be defined as the own most likely path, based on the frequency of turn-offs used by the driver (according to a driver profile) or the motor vehicle; or alternatively (if the driver or motor vehicle has never yet driven on this road), with the turn-off probabilities of vehicles that have a similar movement profile (like the driver/own motor vehicle, they always drive to the place of work at 7:00 in the morning). For example, 80% of these vehicles go left at the intersection, the driver/the motor vehicle itself does not have to have been at this intersection ever before.

In some embodiments, there is no obligation to keep to a single stopping point. In some embodiments, a matrix, starting from a number of possible stopping points, indicates for at least one following traffic light in each case a respective frequency distribution of the traffic light switching state for possible passing directions. For a particular traffic light and a certain passing direction, it is consequently possible to select a first frequency distribution at a first stopping point upon detection of the triggering event and then later, upon reaching the second stopping point and detecting the triggering event, then to select a second frequency distribution there.

The matrix may indicate in the rows the stopping points with observed triggering events and in the columns stopping points at the following traffic lights together with a passing direction/turning-off direction after the traffic light. The passing direction can be designated or specified with the next stopping point that follows driving off at the stopping point of the current traffic light in the respective passing direction. The cells of the matrix thus indicate a frequency distribution of the traffic light state of the following traffic light together with the passing direction (column) for different time intervals that have been observed or detected in the past since the triggering event at the stopping point (row). If a number of stopping points with triggering events have actually been observed ahead of the traffic light currently to be forecast and for the expected passing direction at this traffic light, the associated frequency distributions can be overlaid on the principle described in the following paragraph.

On the basis of the frequency distributions of each stopping point at which the respective triggering event was detected, a combined frequency distribution can then be generated. The determined frequency distributions are therefore combined for forecasting the traffic light switching state of the traffic light. For example, frequency distributions in the form of histograms may be fused or overlaid. In some embodiments, in addition to said stopping point, for this purpose a frequency distribution is also provided for at least one further stopping point along the route for another triggering event, and the frequency distributions of each stopping point at which the respective triggering event was detected are combined to forecast the traffic light switching state by the frequency distribution of the last stopping point with the detected triggering event being used as a basis and any remaining frequency distribution adjusted with a respectively associated time offset, which corresponds to the travel time actually observed in the respective journey up to the triggering event at the last stopping point, i.e. the driving off at the last stopping point.

Therefore, what counts is always the driving off at the last stopping point involving a stop/stopping. All other stopping points with driving off after a stop/stopping are referred to this last driving off/starting (triggering event) via the time offset. What counts is always the time of driving off when at the respective stopping point a red preceding traffic light becomes green or generally a triggering event is observed. Previously passed green preceding traffic lights do not contribute anything in this case, because no triggering event was observed at the stopping points belonging to the preceding traffic lights, and for this reason no frequency distribution can be assigned. Generally, the “green” traffic light switching state can of course also be forecast (green=not red), as will be explained later. This is so because, if there is a red forecast, then there is consequently also a green forecast.

By means of the matrix, said individualized most probable path can also be determined. For this purpose, it is simply necessary to add together the frequency distributions stored in the matrix for each passing direction independently of the time component. This may be restricted to adding together the components of the frequency distributions that originate from the driver, the motor vehicle or a number of or all of the vehicles participating.

In some embodiments, the frequency distribution can be determined or generated. This may take place during ongoing operation of the motor vehicle, that is to say during said journey along the route and on other, previous journeys with the motor vehicle or else with other vehicles. For this purpose, during a stopping phase or red phase at the traffic light or while driving in the direction of or near the traffic light, an actual traffic light switching state of the traffic light is detected and, on the basis of the respectively detected actual traffic light switching state and the respective time interval since detecting the triggering event at a stopping point upstream in the respective journey, the associated frequency distribution is updated. Counting is therefore performed during a stop phase or red phase at the traffic light, i.e. the number of observed traffic light switching states is updated in the frequency distribution.

It should be noted here that, during a single journey, it is preferably not only for a single time that the actual traffic light switching state which is then respectively detectable is determined, but for an entire time interval, i.e. for a number of times or for a number of time intervals, that the actual traffic light switching state is respectively determined. If the motor vehicle therefore stops at the traffic light, it is obviously switched to red, so that for the times of waiting at the traffic light the “red” traffic light switching state can be entered or counted in the frequency distribution in each case. If the motor vehicle drives past a traffic light, it is obviously switched to green, so that the times of passing the traffic light can also be entered into a frequency distribution for the “green” traffic light switching state.

When updating or building up the frequency distribution, when a red phase is detected at the current traffic light, not only the histogram/frequency distribution of the directly preceding stopping point can be updated with a triggering event (not just one column in the described matrix). It is also possible to update all other histograms/frequency distributions of the preceding stopping points with the triggering event observed in the current journey (i.e. driving off after red). You should not go back too far here, so for example a maximum of 10-15 preceding stopping points. Otherwise, the traffic light to be forecast is too far away from the (reference) stopping points with a triggering event.

These updates can only be entered in the correct histograms after passing through the current traffic light, because only after passing through the current traffic light are you aware of the passing direction to which the measured time periods (since driving off at the respective preceding stopping points with a triggering event) belong. The time periods are therefore first measured (for example from approaching preceding stopping point No. 7 to now; from approaching pre-pre-preceding stopping point No. 5 to now) and only entered in all appropriate histograms/frequency distributions from the matrix when it is clear in which direction the traffic light was passed.

Overall, the frequency distribution can be detected by repeatedly passing or driving off the route. By means of a threshold value, it can be specified here from when this frequency distribution is accepted as valid, i.e. contains enough empirical observation data. For example, this may be based on the number of actually detected time intervals of traffic light switching states. The frequency distribution (for example estimated over a histogram) can therefore be completely rebuilt. No pre-assignment is needed. The histogram is only used when a quality criterion, such as for example “More than x observations” (x is the threshold), is reached.

In some embodiments, the current, actual traffic light switching state of the traffic light is also detected by means of a detection device during an approach to the traffic light and the frequency distributions are updated on the basis of the detected actual traffic light switching state. For this purpose, during an approach to the following traffic light, the current, actual traffic light switching state of the respective traffic light is detected, for example by means of a camera, at a number of times together with the respective passing direction (for example green right-turn arrow with red main traffic light) and the frequency distribution is updated on this basis. If the detection device does not provide this accuracy, it is also possible to update the update of the frequency distribution only after the observed passing through of the intersection by the vehicle. Then it is known which way the motor vehicle has taken and data on the state of the traffic light (for example camera images of the traffic light) can be evaluated together with the observed behavior of the motor vehicle (for example “stopped and then turned left”), and consequently update the frequency distribution associated with the turning direction or passing direction.

In some embodiments, not just a single motor vehicle is used to generate the frequency distribution. In some embodiments, from at least one further motor vehicle, state data concerning a respective actual traffic light switching state of the traffic light detected by the further motor vehicle are received, for example by means of a vehicle-to-X communication device (Car-2-X communication) and the frequency distributions are updated on the basis of the state data. Consequently, the traffic light switching state can also be forecast even if it is not within the detection range of the motor vehicle itself, because for example it has never yet passed the traffic light. With the state data, for example:
a) the complete frequency distributions can be transmitted from the other vehicles and these added to the associated ones (same stopping point and same traffic light with the same passing direction) in their own frequency distributions;
b) extracts of a frequency distribution as from a certain point in time in the past can be transmitted from the other vehicles; the remainder as a);
c) instead of the frequency distributions, the driving observations also can be transmitted from the other vehicles (driving off at GPS position XY1 and H1 o'clock. Stopped at GPS position XY2 at H2 o'clock, . . . ). From this, the recipient can himself update the histograms as if he had himself traveled this route with the transmitted driving profile. Updating is then possible just as it is on one's own journey.
d) These are only examples of possible state data.

A person skilled in the art may transmit these data securely in a compressed form.

In connection with the use of a number of motor vehicles for generating the frequency distributions, some embodiments include a central detection of the state data and redistribution from/to the connected vehicles. In some embodiments, there is a server device for operating for example on the Internet. The server device is set up to receive respectively from a number of motor vehicles driving data concerning a predetermined triggering event at a stopping point and state data concerning a respective traffic light switching state, detected by the motor vehicle, of a traffic light passed in a passing direction with time data concerning a respective detection time of the detected traffic light switching state and, on the basis of the state data and the time data of all of the motor vehicles for the triggering event and the passing direction, to generate and provide a frequency distribution, the frequency distribution indicating a respective number of the observed traffic light switching states for different time intervals that have elapsed since the triggering event. The server device may be formed on the basis of a computer or a computer network. The method steps described may be performed by the server device on the basis of a computer program for the server device.

The frequency distribution described so far provides that the switching cycle of each traffic light is operated unchanged. But there are also traffic lights whose switching cycle is switched over during the course of the day and/or on certain days. A development provides that the frequency distribution is selected from a number of frequency distributions intended for different absolute time intervals, that is to say for example times of the day (morning, midday, afternoon, evening, night, respectively defined by a start time and end time) or days of the week, depending on the date and/or or the time of day. In other words, depending on at which of the time intervals (for example time of day, day of the week) the motor vehicle is traveling or driving, another of the frequency distributions is used. Said server device or the control device of the motor vehicle can generate these frequency distributions, for example with the aid of a cluster analysis, from the detected state data with time data of many motor vehicles, to be specific for each observed switching frequency. Consequently, time-variable traffic light controls can be considered.

In some embodiments, a traffic density indication may be taken into account, as may be provided for example by a traffic service, for example via the Internet. There may therefore be a frequency distribution for a number of different value intervals of traffic density indications. As a result, a division of the frequency distributions in dependence on different values or intervals for the traffic density indication can take place, so that traffic-controlled traffic lights that respond to the traffic density can also be taken into account.

Said stopping point for which the triggering event is defined should be chosen such that a triggering event which is possible there correlates with the switching cycle of the following traffic light. In some embodiments, a further, upstream traffic light is provided as a stopping point and the triggering event represents driving off at the upstream traffic light. The triggering event is then a starting of the motor vehicle after the switching to green of the traffic light. This may be detected for example on the basis of the driving speed of the motor vehicle.

A possible criterion for this is that, for a predetermined minimum period of time, for example 1 second, the driving speed must be continuously greater than a predetermined minimum speed, for example 1 m/s, after a predetermined minimum holding period (standstill) has previously been detected at the stopping point. In particular in a built-up area, that is to say for example in a city, traffic lights consecutively arranged along a route are synchronized with respect to their switching behavior, so that the one-time detection of the triggering event (switching to green of a first traffic light) allows a forecast for the traffic light switching state of one or more following traffic lights. A possible alternative stopping point may be for example a railroad crossing, in which case the triggering event may be the opening of the railroad barrier. A possible stopping point may be a bascule bridge or lift bridge on a river, in which case the triggering event may be the release of the bridge after a lockout.

If the traffic light switching state of a traffic light which the motor vehicle is approaching or at which the motor vehicle is waiting is forecast for a time of arrival, or a point of time of arrival, a control can thereby be predictively carried out in the motor vehicle. It may for example be provided that an internal combustion engine of a hybrid drive of the motor vehicle is controlled in dependence on the forecast traffic light switching state of the traffic light. Thus, for example, the switched-off internal combustion engine may not be restarted if it is known that the motor vehicle is approaching a traffic light which will be switched to red when it reaches it. If the red phase can be forecast, this also results in a forecast for the green phase (=not red). Correspondingly, for example the engine may consequently be restarted before or at the end of the red phase.

Possible exemplary applications thus include the following:

(1) Start/stop function—Wait in front of the traffic light—If the traffic light is in any case about to switch to green in the near future, the deactivation of the internal combustion engine will be prevented.
(2) Start/stop function—When green phase is imminent: Activate the internal combustion engine so that it can be accelerated without delay when the driver activates acceleration.
(3) Recuperation: If the next traffic light switches to red and the vehicle is moving: go into recuperation mode in time, especially with mild hybrids, which need a greater distance to bring the motor vehicle to a stop. For all hybrids there is the advantage that the electric machine can be kept in the range of best generator efficiency if the recuperation distance can be freely selected. For this purpose, an output device, for example a haptic pedal (AFFP—accelerator force feedback pedal, active gas pedal), may be provided (driver must take foot off the gas). Also applies to pedelecs that can recuperate. This results in a partial automation. The aim is maximum energy recovery.
(4) Coasting mode: same as 3., but first coasting is ordered, then recuperation to stopping. The correct sequence is ordered. AFFP preferred.
(5) Red/green phase estimates are for example integrated into the vehicle trajectory in said server device (which can be loaded into the motor vehicle), in order thereby to supply energy proactively to the vehicle electrical system, preferably including heating/cooling (predictive battery charging).
(6) Driver receives the notification/information that the next/following traffic light is red, and can then make phone calls or use a smartphone. Before the traffic light switches over, a notification that the traffic light is ‘changing’ or switching over is output.

In some embodiments, there is a control device provided to carry out the methods described including a processor device. In some embodiments, the processor device may comprise a microprocessor or microcontroller. The methods may be implemented on the basis of a program code for the processor device. The control device may be designed as a controller for the motor vehicle. However, the control device may also be designed as a distributed device for partial installation in the motor vehicle and for partial operation outside the motor vehicle, for example on the Internet. On the Internet, this part of the control device may be performed for example by said server device.

The exemplary embodiment explained below is only an embodiment of the teachings herein and does not limit their scope. In the exemplary embodiment, the described components of the embodiment each represent individual features of the teachings which are to be considered independently of one another and which each also develop the scope independently of one another and can therefore also be considered to be a constituent part thereof, either individually or in a combination other than that shown.

Furthermore, the embodiment described may also be supplemented by further features of the disclosure from among those which have already been described.

In the figures, functionally identical elements are respectively provided with the same reference symbols.

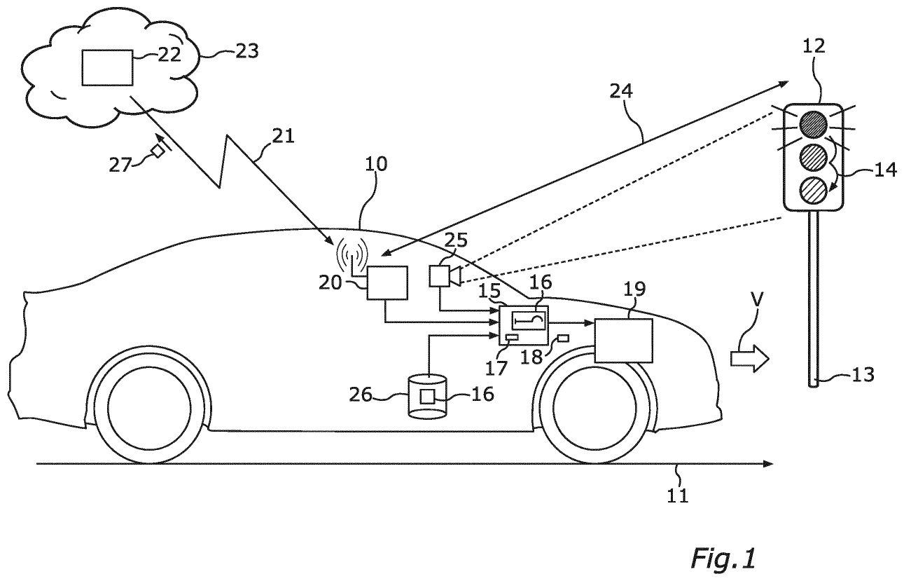

FIG. 1 shows a motor vehicle 10, which may for example be an automobile, in particular a passenger car. In the example shown, the motor vehicle 10 is traveling along a route 11. It is shown that the motor vehicle 10 must stop at a traffic light 12, because the traffic light 12 is switched to red. In the example, a stopping position at a traffic light 12 represents a stopping point 13, which for the further description of the exemplary embodiment is alternatively referred to as stopping point A. If the traffic light 12 switches over from red to green and the motor vehicle therefore drives off, this driving off represents a triggering event 14. In the motor vehicle 10, upon detection of the triggering event 14, a control device 15 may select a frequency distribution 16, which indicates in the control device 15 at which future times as from the triggering event 14 at least one further traffic light downstream of the route 11 will have a certain traffic light switching state for a certain passing direction. Correspondingly, the control device 15 also determines a time period 17 which has elapsed since the triggering event 14, that is to say since the detection time at which it detected the triggering event 14. The control device 15 can determine the anticipated time of arrival at the next traffic light and then use the frequency distribution 16 for the time of arrival to forecast the then probably existing traffic light switching state for one or all of the passing directions at this traffic light.

For example, depending on the present traffic light switching state probably existing at the time of arrival, the control device 15 may generate a control signal 18 for a vehicle component 19, to thereby prepare the vehicle components 19 for a driving behavior of the motor vehicle 10 as will be enforced by the traffic light switching state of the following traffic light. The vehicle component 19 may be for example an internal combustion engine of a hybrid drive of the motor vehicle 10.

From the motor vehicle 10 there are furthermore a communication device 20 for providing a communication link 21 to a server device 22 of the Internet 23 and/or a communication link 24 to another motor vehicle traveling ahead (not shown). From the server device 22, the control device 15 may for example have received the frequency distribution 16. When the connection to another vehicle is established (for example by means of Car-2-X technology), a vehicle may also be a data source instead of the server device 22. The communication links 21, 24 may include for example a mobile radio module and/or a WLAN radio module (WLAN—Wireless Local Area Network).

The vehicle 10 may furthermore comprise an environment sensor 25, for example a camera, by means of which the current, actual traffic light switching state of at least one traffic light can be detected. By means of the environment sensor 25, for example the triggering event 14 can also be detected, that is to say here the green-switching of the traffic light 12. The control device 15 can also detect the triggering event 14 on the basis for example of state data of the motor vehicle 10 itself, for example on the basis of a progression over time of the value 25 of a driving speed V of the motor vehicle 10. A particular advantage may be obtained if the environment sensor can detect the red phase already in the approach ahead of the traffic light. Then the red phase of the traffic light can be entered in the frequency distributions of the preceding stopping points already before stopping.

The vehicle 10 may furthermore include a data memory 26, in which the frequency distribution 16 may be stored.

The actual traffic light switching state of a traffic light 12 determined by means of the environment sensor 25 and/or on the basis of for example the driving speed V can be signaled to the server device 22 via the communication link 21 in the form of state data 27. Transmitted in addition to the state data 27 are time data, which indicate the time of the detected traffic light switching state of a following, that is to say downstream, further traffic light. On the basis of driving data of the motor vehicles, the route 11 covered and stopping points 13 and triggering events 14 can be detected. The driving data may likewise be sent to the server device 22. It should be noted here that only after passing the traffic light in a certain passing direction and reaching or passing the next stopping point can these data be used for a third party. That is why they should also only be transferred later, when all data are available.

The server device 22 may for example have formed or generated the frequency distribution 16 on the basis of the state data 27 with the time data and the driving data of the motor vehicle 10 as well as corresponding state data and time data and driving data of other motor vehicles in the past.

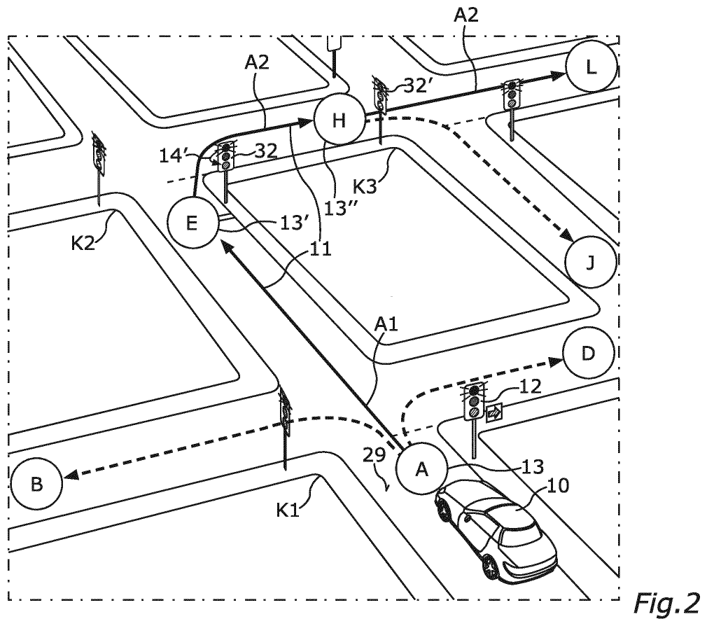

For the further explanation of the example, the current route 11 is shown in more detail in FIG. 2. As explained in connection with FIG. 1, the motor vehicle 10 is at the traffic light 12, which here represents the stopping point 13 (A). The route 11 takes the motor vehicle 10 over three intersections K1, K2, K3. A distinction is made here as to via which stopping point 13 the vehicle 10 in each case enters the intersection and at which next stopping point (13′) the motor vehicle 10 leaves the intersection K1 again. The combination of the stopping point 13 on the approach road 29 and the next possible stopping point 13′ represents a passing direction or short passage A1 over the intersection K1. The passage A1 is therefore the combination of stopping point A and the next stopping point E. The passage A1, as provided by the route 11 shown, consequently corresponds to the combination A1: A-E; a passage A2 corresponds to the combination A2: E-H and a passage A3 to the combination A3: H-L.

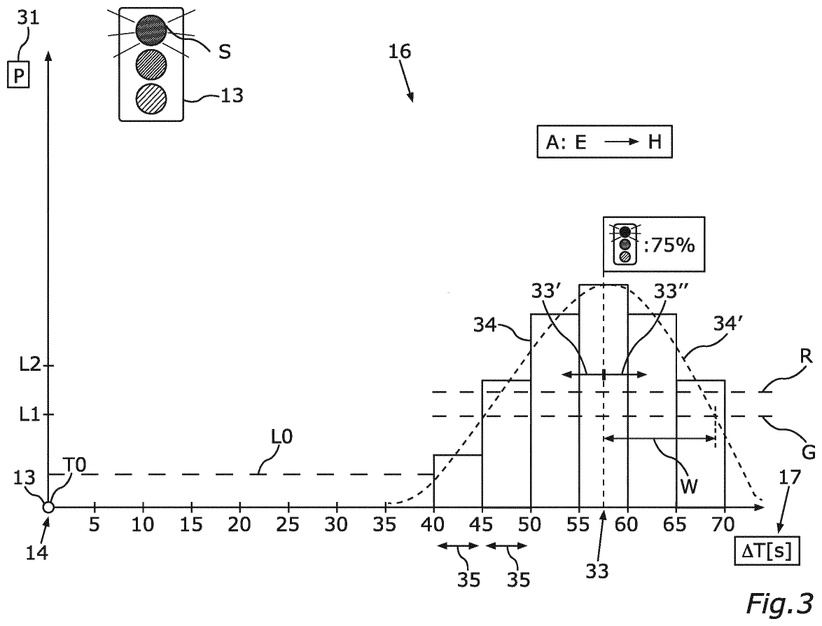

FIG. 3 illustrates an example embodiment of the described frequency distribution 16 as a histogram. Shown is a diagram which may specify for time indications 17, to be specific a time interval ΔT since the triggering event 14, a number 31 or frequency of the traffic light switching state S observed in the past (here “red”) of the next traffic light 32 along the route 11 (passage A2). The state indication 31 may be interpreted as a probability P of the traffic light 32 being switched to red for the respective time interval ΔT. The traffic light 32 is the one that is relevant to the passage A2, that is to say in the example for turning right. This is illustrated in FIG. 3 by the indication of the passage A2: E-H. The detection time T0 of the triggering event 14 corresponds in the frequency distribution 16 to the time 0 of the diagram. Here, the triggering event 14 was detected at the stopping point (A). The frequency distribution 16, as it is shown in FIG. 3, indicates that, as from a time period 17 with the value 40 seconds after the detection time T0, the traffic light 32 could switch to red.

The control device 15 may determine on the basis of the driving speed V a time of arrival 33 at which the motor vehicle 10 will reach the traffic light 32. The current vehicle position and a position of the traffic light 32 can be identified for example on the basis of GPS data and navigation data. On the basis of the frequency distribution 16, the assigned probability P of the “red” traffic light switching state at the time of arrival 33 can be read out. In the example it is stated that, for the time of arrival 33, a probability P of 75% for red is determined. If the motor vehicle 10 is traveling faster, there is a backward shift 33′ of the time of arrival 33. If the vehicle is traveling more slowly, there is a forward shift 33″ of the time of arrival 33.

The frequency distribution 16 in the example may be a histogram 34, which for predetermined time intervals 35 respectively indicates the frequency or the number 31 concerning whether a predetermined traffic light switching state (for example “red”) has been observed. A smoothed progression 34′ may be provided as a frequency distribution 16 from the histogram, for example by means of a parametric function, for example a sum of Gaussian functions (SOG—Sum of Gaussians).

In some embodiments, the frequency distribution may be formed on the basis of a method of machine learning, for example by means of an SVM (Support Vector Machine). For this purpose, the state data 27 with the time data may have been used as training data. On the basis of a red threshold value R and a green threshold value G, for example the control signal 18 for starting or switching off the internal combustion engine can be generated. For example, on the basis of the green threshold value G, an anticipated or (after reaching the traffic light 32) a remaining waiting time W until the traffic light 32 turns green can be forecast. A driver of the motor vehicle 10 when approaching the traffic light 32 can also be given a driving instruction for changing the driving speed V in order to shift the time of arrival 33 by shifting 33′, 33″ into a green phase of the traffic light 32.

The frequency distribution 16 may have been determined for example by the server device 22 on the basis of said driving data, the state data 27 with the time data of a number of motor vehicles. The control device 15 of the motor vehicle 10 may also have generated the frequency distribution 16 exclusively on the basis of its own observation data.

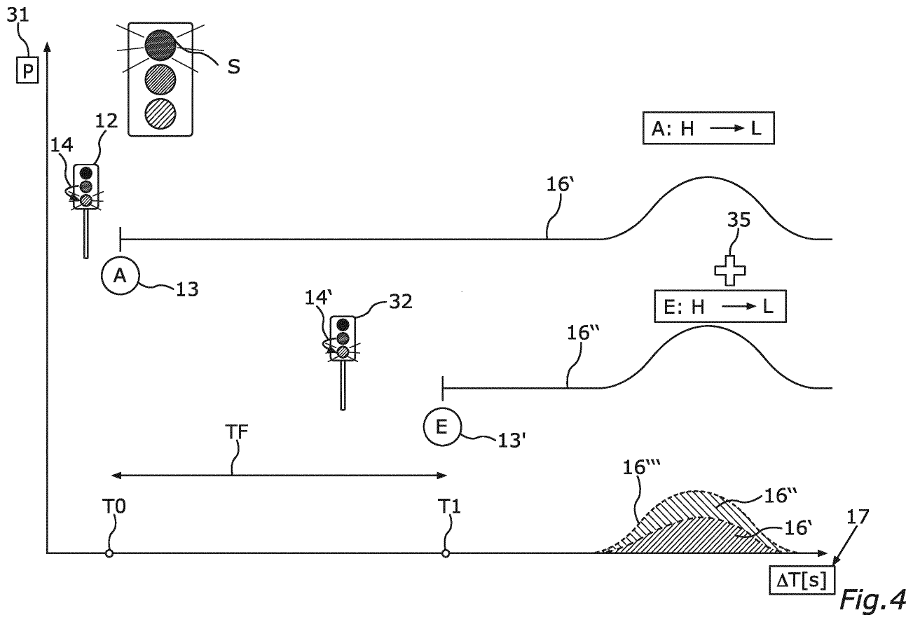

FIG. 4 illustrates furthermore that at stopping point A there can likewise be specified not only for the next traffic light 32 (passage A2) but also for at least one further traffic light 32′ along the route 11 (see FIG. 2) a frequency distribution 16′ with a number 31 of observations, i.e. a probability P of the traffic light state S thereof. In the example used as a basis, this is the traffic light 32′ for the passage A3: H-L. The frequency distribution 16′ provided for this starts from the stopping point A (stopping point 13) and the triggering event 14, which was detected at the detection time T0.

If the motor vehicle 10 must then also stop at the stopping point E (stopping point 13′) at the traffic light 32 for the passage A2, because the traffic light 32 is switched to red, then the subsequent green switching of the traffic light 32 for the stopping point 13′ of the traffic light 32 may likewise represent a triggering event 14′. For this triggering event 14′ at the stopping point 13′ and the route with the passage A3: H-L, a frequency distribution 16″, which is then referred to the detection time T1, can likewise be provided on the basis of the stopping point 13′.

The control device 15 can then generate on the basis of both frequency distributions 16′, 16″ by an overlay 35 (symbolized in FIG. 4 by a + sign) a combined frequency distribution 16′″, which takes into account both the frequency distribution 16′ and the frequency distribution 16″. In this way, in connection with frequency distributions that are based on empirical or probabilistic observation data, a more reliable indication of the probability P of a particular traffic light switching state S for the traffic light 32′ is obtained for the passage A3: H-L. The overlay may take place by adding together the counted number 31 of observations. In this case, the frequency distributions 16′, 16″ must be made to relate to one another in terms of time. This may take place on the basis of the detection times T0 and T1 by measuring the travel time TF. On the basis of the travel time TF, the frequency distribution 16′ is referred to or shifted to the most recently determined frequency distribution 16″.

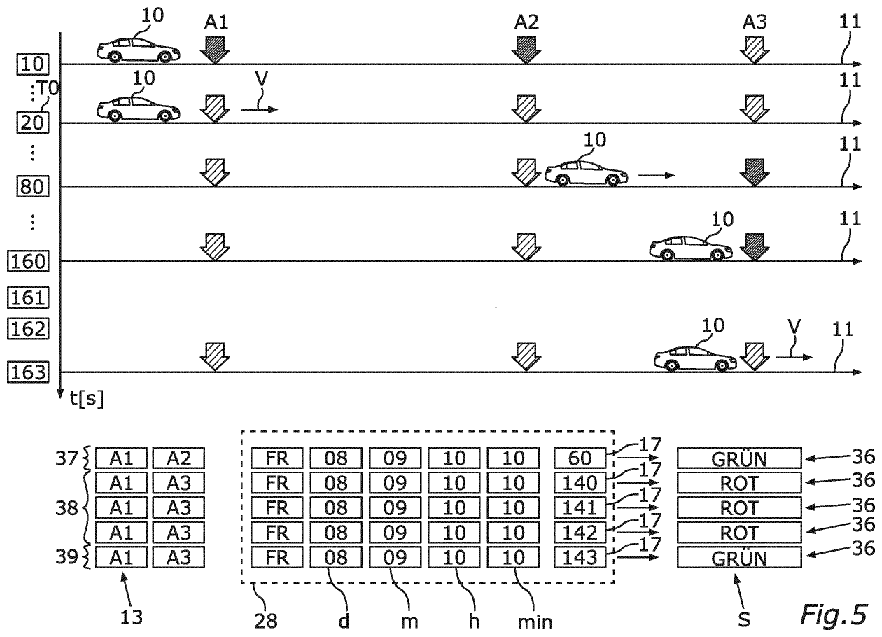

FIG. 5 illustrates how the state data 27 with the time data can be determined by way of example by the motor vehicle 10. It is assumed here that the frequency distribution 16 should first be generated for the route 11. Shown is the drive along the route 11 over time t. For the explanation, it should be assumed that the motor vehicle reaches the traffic light 32 for the passage A2 while the traffic light 32 is switched to green.

First, the motor vehicle 10 waits in the manner described at the traffic light 12 (see FIG. 2), because it is switched to red. This may take place at the time t=10 s, as shown in FIG. 5. When the traffic light 12 switches to green, this is detected by the motor vehicle 10 as the trigger event 14, and consequently the measuring of the time period 17, i.e. the time difference ΔT that has elapsed since the detection time T0, is begun. The detection time T0 is assumed in FIG. 5 at t=20 s.

The motor vehicle 10 can then drive along the route 11 at the driving speed V and for example reach the traffic light 32 for the passage A2 at t=80 s. For this purpose, a first feature vector 36 may then be generated, indicating for the passage A2 starting from the stopping point 13 the traffic light switching state S (GREEN-green) for the time period 17 with the value ΔT=60 s (t minus T0=80 s minus 20 s). In addition, an absolute time indication can also be given, in the example Friday FR, with the month m, the day d, the hour h and the minutes min. Since a passage 37 without stopping is obtained, in the example the feature vector 36 is only formed for one time.

Furthermore, it can be assumed that the motor vehicle 10 reaches the traffic light 32′ for the passage A3 at an absolute time t=160 s. The value ΔT=140 s (t minus T0=160 s minus 20 s) is obtained as the time period 17. The traffic light 32′ should be switched to red. During the resulting stopping phase 38, which then follows, a feature vector 36 for the passage A3 can be generated for each time step to be detected, for example every second. In FIG. 5, three feature vectors 36 are indicated by way of example for a waiting period of 3 seconds. For the time period 17 with the value ΔT=143 s (t minus T0=163 s minus 20 s), a feature vector 36 with the traffic light switching state S of the value GREEN can be generated if at this time the traffic light 32′ switches to green and driving off 39 is possible.

To be able also to form feature vectors already when approaching a traffic light, the environment sensor 25 may be used, by the following traffic light being detected for example by the environment sensor 25, for example filmed, and the lighting state of the traffic light being detected by an image processing method. From a motor vehicle traveling ahead, state data concerning traffic light switching states detected at different observation times or time duration values 17 can also be received via the communication link 24, for example by means of a Car2Car communication, from this motor vehicle traveling ahead.

The feature vectors 36, as they are described, are suitable for training an SVM. By means of the indication of the time duration 17 and the assigned traffic light switching state S, the histogram (see FIG. 3) can also be generated or updated.

The traffic light switching states S of the traffic lights 32, 32′ following along the route 11 can then be forecast by means of the frequency distribution 16, i.e. it can be specified in which time the motor vehicle 10 must stop because the respective traffic light 32, 32′ is switched to red. The frequency distributions 16, 16′, 16″ can also be used to forecast at a red-switched traffic light 32, 32′ when it will be switched to green again. It can be indicated by a threshold value comparison with threshold values L0, L1, L2 (see FIG. 3) how meaningful the respective observation has been so far. When using machine learning, for example an SVM, the respective result can also be provided there with a confidence value, which may be formed for example from a distance measurement in an SVM or from a log likelihood function.

By forming histograms or SVMs, the control device 15 and/or the server device 22 autonomously “learns” the missing or new traffic light switching times from the change. It is also possible to discard outdated data that is older than a predetermined maximum age, in order in this way to allow the “forgetting” of potentially outdated data.

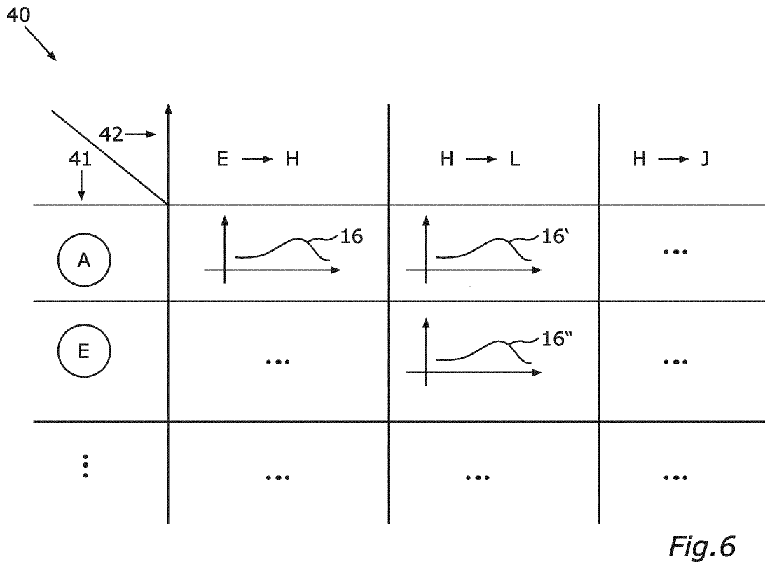

FIG. 6 illustrates how by means of a matrix 40 a number of frequency distributions 16, 16′, 16″ can be provided and/or managed for updating. For a number of stopping points 41, data for a respective histogram 16, 16′, 16″ can be provided and/or stored and/or managed in turn for a number of passages 42 that can be reached by the respective stopping point 41. If a motor vehicle 10 has observed a triggering event at a particular stopping point 41 and then sends new state data 27 after a subsequent passage 42, these may be used for the respective updating of the associated histogram 16, 16′, 16″.

Furthermore, this matrix 40 may also be used for the forecast. If the motor vehicle 10 observes a triggering event at a stopping point 41 and a passage 42 is expected, the associated histogram 16, 16′, 16″ can be read from the matrix 40. In the way described, a probability of the traffic light state S can then be determined from the histogram for an estimated time of arrival 33 (see FIG. 3).

Overall, the example shows how the teachings herein can be embodied to provide a prediction of switching phases of traffic lights on the basis of training runs.

### LIST OF DESIGNATIONS

10 Motor vehicle
11 Route
12 Traffic light
13 Stopping point
13′ Stopping point
13″ Stopping point
14 Triggering event
14′ Triggering event
15 Control device
16 Frequency distribution
16′ Frequency distribution
16″ Frequency distribution
16′″ Frequency distribution
17 Determined time period
18 Control signal
19 Vehicle component
20 Communication device
21 Communication link
22 Server device
23 Internet
24 Communication link
25 Environment sensor
26 Data memory
27 State data
29 Road
31 Number
32 Following traffic light
32′ Following traffic light
33 Time of arrival
34 Histogram
34′ Smoothed progression
35 Time interval
36 Feature vector
37 Passage
38 Stopping phase
39 Driving off
40 Matrix
41 Possible stopping points
42 Possible passages
A1 Passage
A2 Passage
A3 Passage
K1 Intersection
K2 Intersection
K3 Intersection
P Probability
S Traffic light switching state
T0 Detection time
T1 Detection time
TF Travel time
V Driving speed

What is claimed is:

1. A method for forecasting a traffic light switching state of a traffic light for an expected passing direction, wherein the traffic light is to be passed by a motor vehicle during a journey, the method comprising:
defining a triggering event for a predetermined stopping point on a route ahead of the traffic light;
accessing a frequency distribution indicating a respective number of traffic light switching states observed in the past for various time intervals elapsed since the triggering event based at least in part on the triggering event and an expected passing direction;
detecting the triggering event at the stopping point;
determining an expected time of arrival at the traffic light for the motor vehicle; and
estimating the traffic light switching state for the expected passing direction for the time of arrival on the basis of the frequency distribution.

2. The method as claimed in claim 1, wherein, in the event that the route leads over an intersection connecting a number of roads, the passing direction indicates via which possible stopping point of the intersection the motor vehicle reaches the intersection and at which next stopping point the motor vehicle leaves the intersection.

3. The method as claimed in claim 1, further comprising using a most probable route or a route signaled by a navigation device of the motor vehicle to determine the expected passing direction.

4. The method as claimed in claim 1, further comprising using a matrix indicating, for a number of possible stopping points, for at least one following traffic light in each case a respective frequency distribution for its traffic light switching state for multiple possible passing directions.

5. The method as claimed in claim 1, further comprising determining a frequency distribution for at least one further stopping point along the route for another triggering event; and
combining the frequency distributions of each stopping point at which the respective triggering event was detected to forecast the traffic light switching state using the frequency distribution of the last stopping point being used as a basis and any remaining frequency distribution adjusted with a respectively associated time offset corresponding to a travel time up to the last stopping point.

6. The method as claimed in claim 1, further comprising, during a stopping phase at the traffic light, detecting an actual traffic light switching state of the traffic light; and
updating the frequency distribution on the basis of the respectively detected actual traffic light switching state and the respective time interval since detecting the triggering event.

7. The method as claimed in claim 1, further comprising detecting a current, actual traffic light switching state of the traffic light using a detection device during an approach to the traffic light; and
Updating the frequency distribution on the basis of the detected actual traffic light switching state.

8. The method as claimed in claim 1, further comprising receiving a respective actual traffic light switching state from at least one further motor vehicle; and
updating the frequency distribution on the basis of the received data.

9. The method as claimed in claim 1, further comprising selecting the frequency distribution from a number of frequency distributions, based at least in part on the date and/or the time of day and/or traffic density indications.

10. The method as claimed in claim 1, further comprising controlling an internal combustion engine of a hybrid drive of the motor vehicle and/or a start/stop function of an internal combustion engine and/or an output device for outputting a notification of the switching state of the traffic light to a driver of the motor vehicle based at least in part on the forecast traffic light switching state of the traffic light.

11. The method as claimed in claim 1, further comprising providing a stopping position at a traffic light as a stopping point; and
wherein the triggering event represents driving off at the traffic light.

12-13. (canceled)

14. A server device comprising:
a memory;
a processor; and
a communication interface configure to receive respectively from a number of motor vehicles state data concerning a predetermined triggering event and a respective traffic light switching state, detected by the motor vehicle, of a traffic light passed in a passing direction with time data concerning a respective detection time of the detected traffic light switching state;
wherein the processor accesses instructions stored in the memory, the instructions, when loaded and executed by the processor, causing the processor to:
on the basis of the state data with the time data of all of the motor vehicles for the respective triggering event and the passing direction, generate and provide a frequency distribution indicating a respective number of the observed traffic light switching states for different time intervals elapsed since the respective triggering event.
